(19) United States
(12) Patent Application Publication
(10) Pub. No.: US 2023/0067323 A1
(43) Pub. Date: Mar. 2, 2023

(54) Popcorn Dehydration Apparatus And Method

(71) Applicants: Russell Hopper, Leavenworth, KS (US); Dolli Richardson, Leavenworth, KS (US)

(72) Inventors: Russell Hopper, Leavenworth, KS (US); Dolli Richardson, Leavenworth, KS (US)

(21) Appl. No.: 17/410,521

(22) Filed: Aug. 24, 2021

(51) Int. Cl. A47J 39/00; A47J 39/02; A23L 5/20; A23L 3/16

(52) U.S. Cl. CPC A47J 39/003; A47J 39/02; A23L 5/21; A23L 3/165; A23V 2002/00

(57) ABSTRACT

An apparatus and method for dehydrating a quantity of previously air popped corn so as to maintain its crunchiness includes a support ring having an upstanding continuous peripheral wall configured to nest atop an upper edge of a receptacle, the upstanding continuous peripheral wall being complementary to an open top of the receptacle and defining an interior area. A distribution conduit having a cylindrical configuration is coupled to an inner surface of the support ring and has opposed upstream and downstream ends defining a channel therebetween. The upstream and downstream ends are open and the distribution conduit has an elongate configuration and is oriented axially relative to the support ring. A blow-drying device may be releasably mounted in the upstream end of the distribution conduit for generating a heated air stream and blowing the generated heated air stream from the upstream to the downstream end when energized.

### BACKGROUND OF THE INVENTION

This invention relates generally to food warming devices and, more particularly, to an apparatus and method for dehydrating a quantity of previously popped and stored popcorn so as to retain the crunchiness thereof.

Popcorn, sometimes referred to as popped corn, is a corn kernel that rapidly expands when heated. Air popped popcorn is traditionally made with a special appliance. The air popper circulates hot air around the popcorn kernels. When they get hot enough, the kernels pop, forcing them out of the popping bowl and into a nearby storage area. Popcorn kernels are often packaged in bags or jars for consumers to purchase from a grocery store and then to heat in a microwave or on a stove so as to generate a bag or tub of expended kernels to eat as a snack. Bags or tubs of popcorn are also a routine staple snack at movie theaters, carnivals, and are even obtainable from retail stores dedicated to making and selling popcorn. Accordingly, it is imperative that popcorn obtained at the movies or from commercial vendors be hot, fresh, and crunchy.

Unfortunately, popcorn obtained at the movies or from retail stores is often stale and has lost its crunch. This may be the result of excess popped corn being packaged for too long prior to purchase. Its moisture content causes the air popped corn to lose its crunch before it can be consumed. This is especially problematic if a retail popcorn seller desires to make large quantities of popcorn prior to sale and consumption, in that the prior popped corn will lose its crunch and be perceived as being old and stale. Conversely, if the popcorn is not made in bulk, a problem is that a rush of customers seeking to purchase popcorn may result in long lines and customers having to wait for fresh popcorn to be popped and served.

Various devices are known or proposed for heating popcorn or, more generally, warming or drying food or confections. Although presumably effective for their intended purposes, the existing devices do not dehydrate or bake popcorn so as to retain the crunchiness thereof.

Therefore, it would be desirable to have an apparatus and method for dehydrating a quantity of previously air popped corn in real time just before it is needed for retail sale such that the previously prepared popcorn tastes warm, fresh, and crunchy for the consumer. Further, it would be desirable to have an apparatus and method for dehydrating popcorn that virtually eliminates the customer having to wait for fresh popcorn, even in times of high demand. In addition, it would be desirable to have an apparatus and method for dehydrating popcorn that enables a maker of many flavors of popcorn to maintain a steady, daily, and sufficient inventory of said flavors of popcorn without having to clean and replace the flavoring mechanism every time a customer orders a different flavor of popcorn.

### SUMMARY OF THE INVENTION

Accordingly, an apparatus and method according to the present invention, for dehydrating a quantity of previously air popped corn and now stored in a receptacle so as to maintain its crunchiness, includes a support ring having an upstanding continuous peripheral wall configured to nest atop an upper edge of the receptacle, the upstanding continuous peripheral wall being complementary to an open top of the receptacle and defining an interior area. A distribution conduit having a pipe-like configuration is coupled to an inner surface of the support ring and has opposed upstream and downstream ends, defining a channel therebetween. The upstream and downstream ends are open, and the distribution conduit has an elongated configuration and is oriented axially relative to the support ring. A blow-drying device may be releasably mounted proximate the upstream end of the distribution conduit for generating a heated air stream and blowing the generated heated air stream from the upstream to the downstream end when energized, so as to push that heated air stream through the previously popped kernels and, thereby, drying them.

Therefore, a general object of this invention is to provide a popcorn dehydrating apparatus for drying and dehydrating a stored quantity of previously popped kernels.

Another object of this invention is to provide a popcorn dehydrating apparatus, as aforesaid, that virtually eliminates the customer having to wait for fresh popcorn, even in times of high demand.

Still another object of this invention is to provide a popcorn dehydrating apparatus, as aforesaid, that enables a maker of many flavors of popcorn to make a large enough quantity of a single flavor of popcorn for at least a whole day without having to clean and replace the flavoring mechanism every time a customer orders a different flavor of popcorn.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an apparatus for dehydrating previously popped kernels of popcorn according to an embodiment of the present invention;

FIG. 2a is an exploded view of the dehydrating apparatus as in FIG. 1;

FIG. 2b is a block diagram illustrating the electrical components of the blow-drying device;

FIG. 3a is a side view of the dehydrating apparatus as in FIG. 1;

FIG. 3b is a sectional view taken along line 3b-3b of FIG. 3a;

FIG. 4a is a perspective view of an apparatus for dehydrating previously popped kernels of popcorn according to another embodiment of the present invention; and

FIG. 4b is a block diagram illustrating the electronic components of the dehydrating apparatus as in FIG. 4a.

### DESCRIPTION OF THE PREFERRED EMBODIMENT

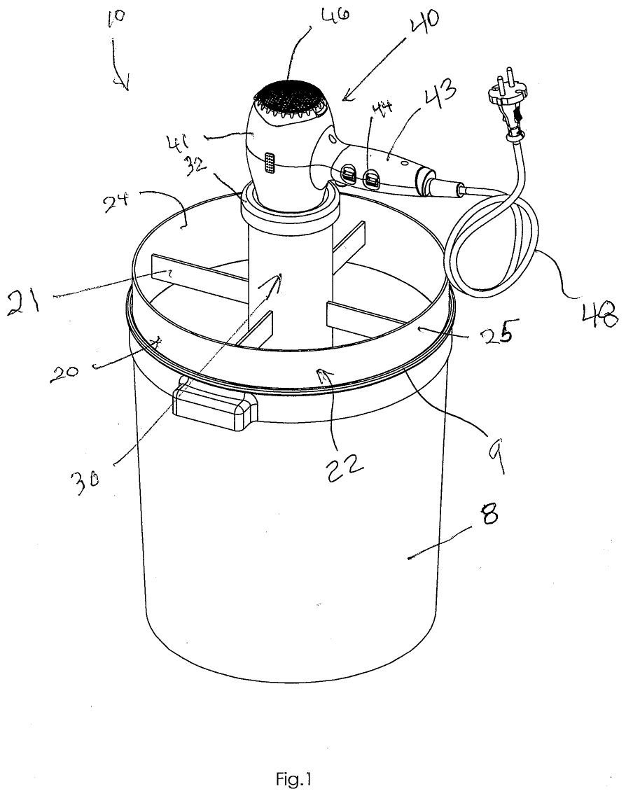

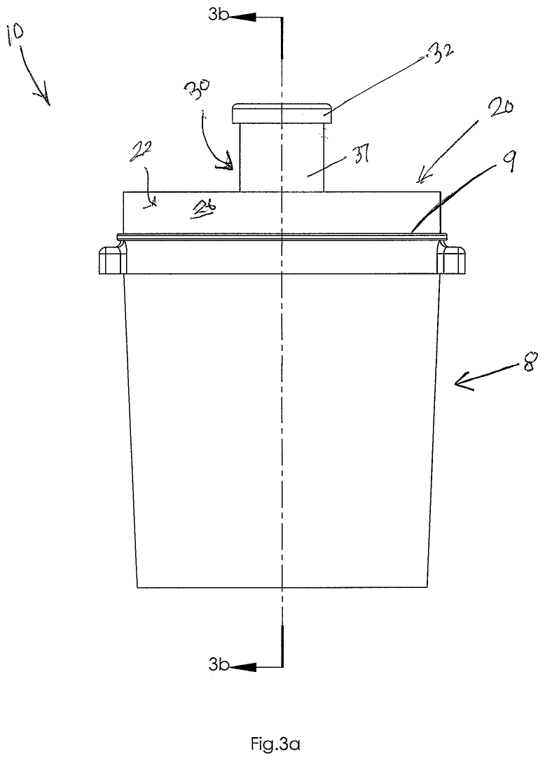

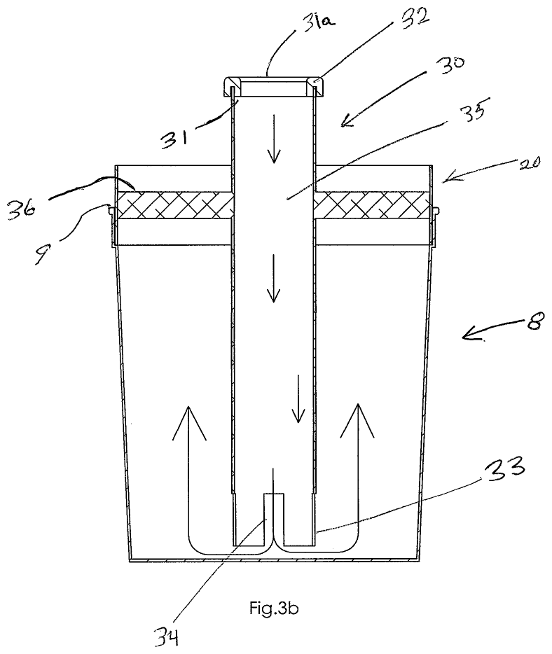

An apparatus and method for dehydrating previously popped and stored popcorn according to a preferred embodiment of the present invention will now be described with reference to FIGS. 1 to 4b of the accompanying drawings. The dehydrating apparatus 10 includes a support ring 20 that may be nested at top a popcorn storage receptacle 8, a distribution conduit 30 for blowing a heated air stream into the receptacle 8 of previously popped kernels, and a blow-drying device 40 operative to generate a heated air stream that is then directed evenly into the receptacle 8 so as to dehydrate the previously stored popcorn, whereby to maintain the crunchiness of the stored popcorn.

The support ring 20 provides the interface between a receptacle 8 containing previously heated and popped popcorn kernels and a stream of heated air that is operative to dehydrate and dry the previously popped corn stored in the receptacle. In other words, a seller of air popped corn (i.e., popcorn) is enabled by the present invention to pop large quantities of popcorn, store it in buckets, tubs, or other receptacles, and later remove a predetermined amount of moisture from the stored popcorn (i.e., dehydrate the stored popcorn) and sell it as freshly popped popcorn. As will be described in more detail, the apparatus and method for dehydrating and heating previously popped and stored popcorn maintains, imparts, or recaptures the crunchiness that implies the stored popcorn was freshly made or baked.

More particularly, the support ring 20 may include an upstanding peripheral wall having a continuous or circular configuration. The support ring 20 may be referred to as a band or as the cross-section of a cylinder, the support ring 20 having an inner surface 24 and an outer surface 26 and which defines an open interior area 28, which may also be referred to as a through-bore. As shown, the support ring 20 is hollow, having an open bottom and open top. Preferably, the upstanding peripheral wall 22 is releasably positioned or nested atop an upper edge 9 of the receptacle 8. In an embodiment, the support ring 20 has a diameter and dimension that is complementary to a diameter of the receptacle 8 so as to facilitate the nested configuration (FIG. 1).

In an embodiment, the distribution conduit 30 may have a cylindrical configuration in the manner of a pipe. The distribution conduit 30 may have an upstream end 31 opposite a downstream end 32, and both ends are open. The distribution conduit 30 is hollow and defines an interior channel 35 extending between the upstream end 31 and downstream end 32. As will be explained in greater detail below, heated air will be blown into the distribution conduit 30 through the upstream end 31 and blown in the direction of the downstream end 33.

The distribution conduit 30 may be coupled to an inner surface of the upstanding peripheral wall 22 of the support ring 20 with a plurality of struts 21 each having an equal length such that the distribution conduit 30 is centered in its displacement from the support ring 20. Further, the distribution conduit 30 has an elongated configuration defining an imaginary vertical axis that is parallel to an imaginary vertical axis defined by the upstanding peripheral wall 22 of the support ring 20. The distribution conduit 30 is axial relative to the support ring 20. Even more particularly, the distribution conduit 30 may include an upper section 37, extending upwardly away from the support ring 20, and a lower section 38 extending downwardly away from the support ring 20. It is understood that the lower section 38 has a length that is longer than a length of the upper section 37 as it, preferably, extends to the bottom of the receptacle 8 where heated air will flow from the downstream end 33 so as to heat the stored popcorn. In an embodiment, the conduit may have a twisted or spiral shaped configuration such that the heated air stream will swirl like a vortex into the receptacle of popcorn. It is believed that this may enhance and cause a more consistent and thorough heating, reconditioning, or dehydrating of the stored popcorn.

In a related aspect, the downstream end 33 of the distribution conduit 30 may define a plurality of slots 34 laterally spaced apart from one another such that the heated stream of air is evenly distributed into the receptacle 8 of popped kernels. In other words, the heated air directed evenly approximate the bottom of the receptacle 8 then naturally rises toward the top, where the air is allowed to escape through the otherwise open support ring 20.

The key to maintaining or introducing the crunchiness to the previously popped corn stored in the receptacle 8 is to force hot air into the bottom of the receptacle 8 so as to dry and dehydrate the moisture content or relative humidity of the sealed popcorn receptacle 8. According to the present invention, a stream of heated ambient air is blown downstream through the interior channel 35 of the distribution conduit 30 such that the heated air stream is evenly diffused through the plurality of slots 34 and into the plurality of popcorn kernels stored in the receptacle 8.

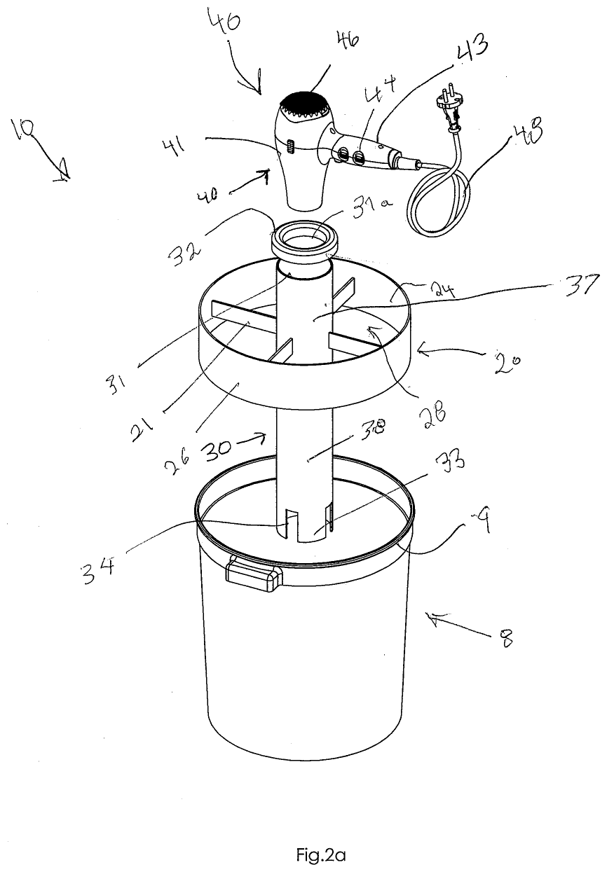

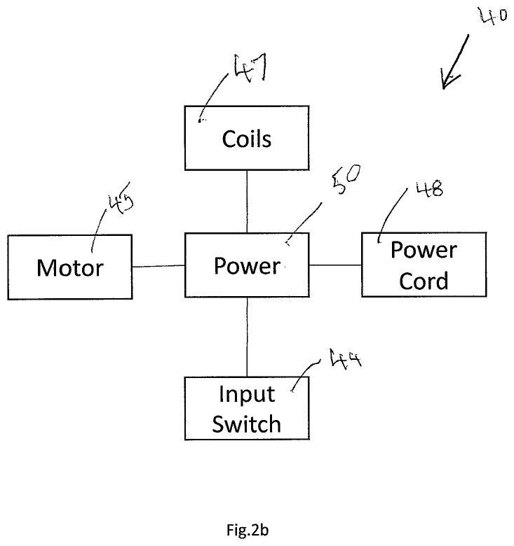

One means for generating the heated air stream is a 1,875-watt blow-dryer (also referred to as a blow-drying device 40). Heating elements having more or less power are possible, of course, although this will have an effect on how fast a receptacle of previously popped corn can be sufficiently dehydrated, as will be discussed further later. It is understood that the blow-dryer may be connected to a power source such as AC current via a power cord 48 plugged into a wall outlet. The electric components of the blow dryer are shown in FIG. 2b. Having a traditional construction, the blow-drying device 40 includes a housing 41 defining an interior space and, optionally, may include a handle 43. Further, a plurality of heating coils 47 is situated in the interior space and is operative to heat ambient air therein when energized. Heating elements convert electricity into heat through the process of resistive heating. The electric current passing through the element encounters resistance, which produces heat. Typically, heating elements are made from a coil, ribbon, or the like. Further, the blow-drying device 40 may include a motor 45 electrically connected to a fan 46 and mounted in the interior space of the housing 41 in proximity to the outlet port 42 such that ambient air surrounding the coils is heated and blown forcefully through the outlet port 42 when said electronics are energized.

The blow-drying device 40 includes at least one input control 44 situated on the handle 43 or housing itself, the input control 44 being electrically connected for selectively actuating and energizing the other components. It is understood that the plurality of coils 47, motor 45, and fan 46 may be electrically connected to the at least one input control 44. Accordingly, the heated air stream is generated when the user actuates the at least one input control 44, which causes the circuitry to energize the components as described above. The electronics of the blow-drying device 40 may be selectively energized by connection of the input control 44 with an A/C power source 50 of electrical power, such as supplied by a wall outlet.

In use, the blow-drying device 40 may be coupled to the upstream end 31 of the distribution conduit 30 and, more particularly, the outlet port 42 is inserted into the open upstream end 31 so that the heated air stream is blown by the fan 46 downstream through the interior channel 35 and out through the slots 34 at the downstream end 33. In an embodiment, the distribution conduit 30 may include a cap member coupled to the upstream end 31 defining an aperture 31a suitable for receiving the outlet port 42 of the blow-drying device 40. The cap member may also be referred to as an auxiliary support ring 32 as it may be constructed of a silicon material that is more particularly suited to support and grip the outlet port 42 of a blow-drying device 40. More particularly, the aperture of the auxiliary support ring 32 may have a diameter that is different than the diameter associated with the upstream end 31 and that is complementary to a diameter of the outlet port 42 so as to enhance and improve a seal when the outlet port 42 is inserted into the upstream end 31 of the distribution conduit 30.

In an embodiment (not shown), a larger receptacle 8 may be used to store larger quantities of popcorn, such as a 20-gallon bucket or tub. In such an embodiment, the support ring may be larger in dimension so as to nest atop the larger bucket and may include a pair of distribution conduits. Further, a pair of blow-drying devices may be used for dehydrating the larger quantity of stored popcorn. In addition, it is understood that blow-drying devices operating at speeds other than with a 1,875-watt device are possible although this will proportionately increase or decrease the amount of time the heated air needs to be blown into the stored popcorn receptacle.

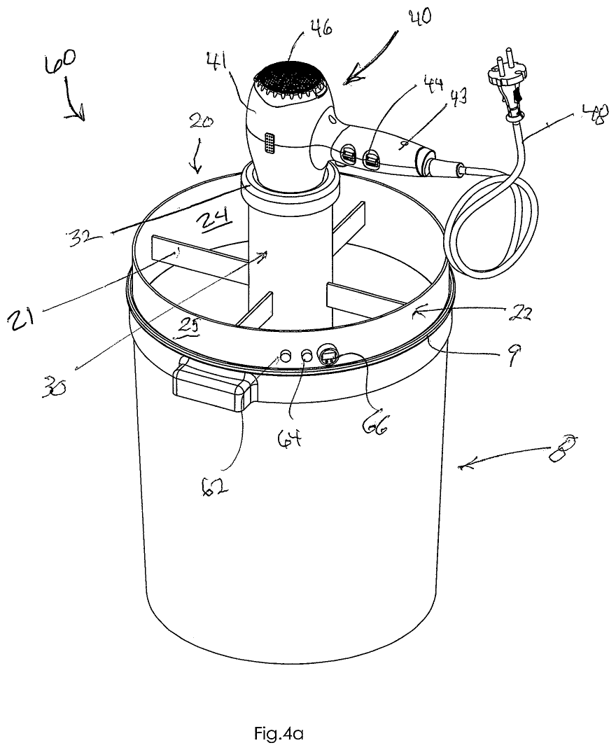

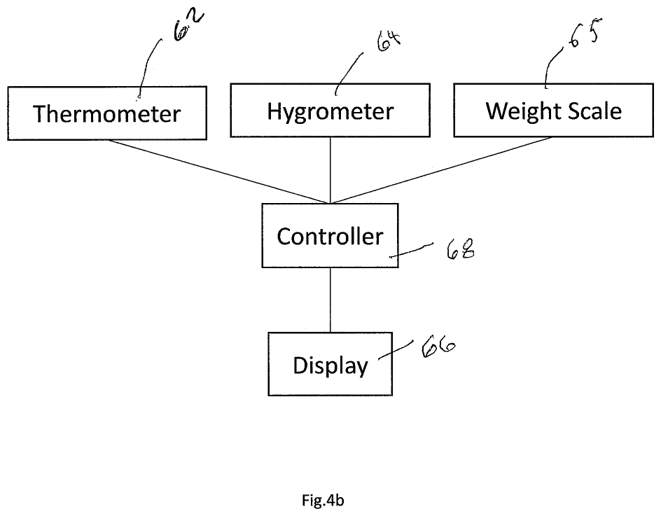

In another embodiment (FIG. 4a), a dehydrating apparatus 60 may include electronics capable of determining temperature and humidity data. More particularly, the embodiment described herein may include an electronic display 66 and a controller 68 that is in electronic communication with the display 66 and may include program code or hardwired instructions. The dehydrating apparatus 60 according to this embodiment may include a thermometer 62 in data communication with the controller 68 along with programming for generating temperature data indicative of a current ambient temperature. In other words, the controller needs to know the temperature of surrounding ambient air before actuating a drying or dehydrating process. Similarly, the dehydrating apparatus 60 according to this embodiment may include a hygrometer 64 in data communication with the controller 68 along with programming for generating humidity data indicative of a relative humidity. In other words, the controller 68 needs to know a relative humidity of the surrounding ambient air before actuating a drying or dehydrating process. Based on a current temperature and a current relative humidity, the controller 68 may be configured to determine an exact amount of time for running the motor of the blow-drying device 40 and sealing of the receptacle 8. Further, the temperature data and humidity data may be published on the electronic display 66. In an embodiment, the dehydrating apparatus 10 may include a weight scale 68 as the overall quantity of the popcorn reservoir will have an effect on the time and temperature needed for dehydration. In an embodiment, the thermometer, hygrometer, and weight scale may be in data communication with a processor or controller 68 that is configured (via firmware or software) to calculate and actuate the heating and drying process automatically based on the sensor readings.

When utilizing this invention, the consumer can expect the dehydrating process to take around 15 minutes, not including the drying process. The air popped corn may be placed into the apparatus 10 and the blow-drying device 40 may be switched on. On average, it should take 10-12 minutes to heat the inside of the container to 110° F., the minimum heat required to dehydrate the popped corn. Once the internal temperature has reached or exceeded that temperature, the popped corn should sit inside the container for an additional three minutes in order to dehydrate the popped corn fully. The goal is to decrease the moisture content in the popped corn to 20%. The ratio for the ideal moisture content is

$$20 = \frac{{W}_{Original} - {W}_{Final}}{{W}_{Original}} .$$

Using this, and a measurement of the weight of the popped corn before heating, the ideal final weight of the popcorn can be obtained, and a more exact measurement regarding time to dehydrate can be made. For context, an ideal popcorn kernel is around 14% water, which is why the 20% threshold works.

For simplicity, Tₜₒₜₐₗ=3+T_{heating}, which is estimated to be around 15 minutes. For a more exact equation, the user can utilize Newton's law of cooling rearranged:

$$t = \frac{- log ( \frac{{T}_{Final} - {T}_{Atmosphere}}{{T}_{Initial} - {T}_{Atmosphere}} )}{k} ;$$

where t is time, k is the cooling coefficient, and T are the various temperatures; to determine an exact cooling time needed. An ideal popcorn kernel, for the sake of upmost simplicity, has a cooling coefficient of about 0.5. In this case, the temperatures would be Tᵢₙᵢₜᵢₐᵢ−110°, T_{Atmosphere} is the temperature of the surrounding air, and T_{Final}≥T_{Atmosphere}+T_{Atmosphere}*0.2. With these assumptions, s user (e.g., a popcorn shop owner) can calculate the time needed to cool the popcorn to an appropriate temperature by using the temperature of the popcorn after heating, 110° F., the temperature of the surroundings, and the goal temperature, which is the temperature of the surroundings plus 20%.

There is another step to the methodology of the present invention that is critical to its successful implementation. Namely, it is critical that the stored popcorn not be overly dehydrated/dried as this causes a negative result, such as changing the flavor of the popcorn itself. In other words, if the previously popped popcorn is dehydrated for too long or at too high a temperature, the flavor of the stored popcorn may be transformed or lost altogether. Accordingly, the heated air stream may be switched to a lower heat setting so as to maintain the target settings in a case where the treated popcorn cannot be immediately served. In an embodiment, the controller may be configured (i.e., programmed) to automatically switch the heating element to a lower temperature setting once the predetermined time for dehydration has ended. In other words, there may be a built-in configuration for requiring the heated popcorn to “rest” (wait while the moisture dissipates) before it can be served.

It is understood that while certain forms of this invention have been illustrated and described, it is not limited thereto except insofar as such limitations are included in the following claims and allowable functional equivalents thereof.

1. An apparatus for drying previously popped kernels that are stored in a receptacle, said drying apparatus, comprising:
a support ring having an annular configuration that is complementary to an open mouth of the receptacle, said support ring defining an interior area;
a distribution conduit including a continuous side wall having an upstream end and a downstream end opposite said upstream end and defining an interior channel through which an air stream is directed downstream, said distribution conduit being coupled to an inner surface of said support ring,
wherein said upstream and downstream ends are open and said distribution conduit has an elongate configuration and is oriented axially relative to said support ring.

2. The drying apparatus as in claim 1, further comprising a blow-drying device releasably mounted proximate said upstream end of said distribution conduit for generating a heated air stream and directing said generated heated air stream into said distribution conduit, when energized, via said upstream end.

3. The drying apparatus as in claim 2, wherein said blow-drying device includes:
a housing defining an interior space and having an outlet port in communication with said interior space;
a plurality of heating coils situated in said interior space and operative to heat ambient air when energized; and
a motor electrically connected to a fan mounted in said interior space for blowing said heated ambient air outwardly through said outlet port when energized.

4. The drying apparatus as in claim 4, wherein said blow-drawing device includes:
a power source; and
at least one input control situated on said housing and electrically connected to said power source, to said plurality of heating coils, to said motor, and to said fan, said at least one input control being operative to allow electrical current to flow from said power source to said plurality of heating coils and said motor when actuated.

5. The drying apparatus as in claim 4, wherein said distribution conduit includes an auxiliary support ring mounted to said upstream end of said blow-drying device, said auxiliary support ring defining an aperture defining a diameter that is different than a diameter associated with said outlet port of said blow-drying device and complementary thereto so as to receive and hold said outlet port in said upstream end of said distribution conduit in a sealed configuration.

6. The drying apparatus as in claim 1, wherein said distribution conduit is coupled to said support ring with a plurality of struts each having an equal length and being laterally spaced apart from one another such that said distribution conduit is centered atop the receptacle.

7. The drying apparatus as in claim 1, wherein said distribution conduit defines a plurality of slots each being adjacent said downstream end and laterally spaced apart from one another, whereby to evenly distribute said heated air stream.

8. The drying apparatus as in claim 1, further comprising:
a display;
a controller in data communication with said display;
a thermometer in data communication with said controller and configured to generate temperature data indicative of a current ambient temperature;
a hygrometer in data communication with said controller and configured to generate humidity data indicative of a relative humidity;
wherein said controller is programmed to determine, using said temperature data and said humidity data, a run time parameter indicative of how long said blow-drying device is actuated;
wherein said controller is programmed to publish said temperature data and said humidity data and said run time parameter on said display.

9. The drying apparatus as in claim 1, wherein said blow-drying device is a 1,875 Watt hairdryer.

10. The drying apparatus as in claim 1, wherein said support ring has an upstanding continuous peripheral wall configured to nest atop to an upper edge of the receptacle.

11. An apparatus for drying previously popped kernels that are stored in a receptacle, said drying apparatus, comprising:
a support ring having an upstanding continuous peripheral wall configured to nest atop an upper edge of the receptacle, said upstanding continuous peripheral wall being complementary to an open mouth of the receptacle and defining an interior area;
a distribution conduit including a cylindrical configuration having an upstream end and a downstream end opposite said upstream end and defining an interior channel through which an air stream is directed downstream, said distribution conduit being coupled to an inner surface of said support ring,
wherein said upstream and downstream ends are open and said distribution conduit has an elongate configuration and is oriented axially relative to said support ring; and
a blow-drying device releasably mounted proximate said upstream end of said distribution conduit for generating a heated air stream and blowing said generated heated air stream from said upstream to said downstream end when energized.

12. The drying apparatus as in claim 11, wherein said blow-drying device includes:
a housing defining an interior space and having an outlet port in communication with said interior space;
a plurality of heating coils situated in said interior space and operative to heat ambient air when energized; and
a motor electrically connected to a fan mounted in said interior space for blowing said heated ambient air outwardly through said outlet port when energized.

13. The drying apparatus as in claim 13, wherein said blow-drying device includes:
a power source; and
at least one input control situated on said housing and electrically connected to said power source, to said plurality of heating coils, to said motor, and to said fan, said at least one input control being operative to allow electrical current to flow from said power source to said plurality of heating coils and said motor when actuated.

14. The drying apparatus as in claim 13, wherein said power source is AC electricity.

15. The drying apparatus as in claim 11, wherein said distribution conduit includes an auxiliary support ring mounted to said upstream end of said blow-drying device, said auxiliary support ring defining an aperture defining a diameter that is different than a diameter associated with said outlet port of said blow-drying device and complementary thereto so as to receive and hold said outlet port in said upstream end of said distribution conduit in a sealed configuration.

16. The drying apparatus as in claim 11, wherein said distribution conduit is coupled to said support ring with a plurality of struts each having an equal length and being laterally spaced apart from one another such that said distribution conduit is centered atop the receptacle.

17. The drying apparatus as in claim 11, wherein said distribution conduit defines a plurality of slots each being adjacent said downstream end and laterally spaced apart from one another, whereby to evenly distribute said heated air stream.

18. The drying apparatus as in claim 11, further comprising:
a display;
a controller in data communication with said display;
a thermometer in data communication with said controller and configured to generate temperature data indicative of a current ambient temperature;
a hygrometer in data communication with said controller and configured to generate humidity data indicative of a relative humidity;
wherein said controller is programmed to determine an amount of time for activating said blow-drying device using said temperature data and said humidity data;
wherein said controller is programmed to publish said temperature data and said humidity data and said determined amount of time on said display.

19. A method for drying previously popped kernels that are stored in a receptacle, said drying method, comprising:
positioning a support ring atop an upper edge of the receptacle, said support ring having annular configuration complementary to an open mouth of the receptacle and defining an open interior area;
positioning a distribution conduit in said interior area of said support ring through which an air stream is directed between an open upstream end and an open downstream end in communication with the receptacle, said distribution conduit being coupled to an inner surface of said support ring;
wherein said upstream and downstream ends are open and said distribution conduit has an elongate configuration and is oriented axially relative to said support ring so as to extend into the receptacle; and
generating a maximum heated air stream and blowing said generated maximum heated air stream into said upstream end of said distribution conduit for passage to said downstream end.

20. The drying method as in claim 19, further comprising:
determining an ambient air temperature via a thermometer situated proximate the receptacle;
determining a relative humidity via a hygrometer situated proximate the receptacle;
determining a duration of time for said generating said maximum heated airstream via a controller in data communication with said thermometer and said hygrometer.

21. The drying method as in claim 20, further comprising:
upon expiration of said determined duration of time, blowing a maintenance airstream through said distribution conduit, said maintenance heated air stream having a lower temperature than said maximum heated air stream.

22. The drying method as in claim 19, wherein:
said downstream end of said distribution conduit defines a plurality of slots each being spaced apart from an adjacent slot;
said heated air stream is generated by a blow-dryer; and
said distribution conduit is coupled to said support ring with struts having an equal length so as to be axially centered in said interior area and to evenly distribute said heated air stream into the receptacle.

23. The drying apparatus as in claim 20, wherein said blow-drying device includes:
a housing defining an interior space and having an outlet port in communication with said interior space;
a plurality of heating coils situated in said interior space and operative to heat ambient air when energized; and
a motor electrically connected to a fan mounted in said interior space for blowing said heated ambient air outwardly through said outlet port when energized.

24. The drying apparatus as in claim 21, wherein said blow-drying device includes:
a power source; and
at least one input control situated on said housing and electrically connected to said power source, to said plurality of heating coils, to said motor, and to said fan, said at least one input control being operative to allow electrical current to flow from said power source to said plurality of heating coils and said motor when actuated.
